(19) United States
(12) Patent Application Publication
(10) Pub. No.: US 2003/0233533 A1
(43) Pub. Date: Dec. 18, 2003

(54) Boot from cache

(75) Inventor: Meir Avraham, Rishon Lezion (IL)

Correspondence Address: DR. MARK FRIEDMAN LTD., C/o Bill Polkinghorn, Discovery Dispatch, 9003 Florin Way, Upper Marlboro, MD, 20772, US

(73) Assignee: M-SYSTEMS FLASH DISK PIONEERS LTD.

(21) Appl. No.: 10/167,402

(22) Filed: Jun. 13, 2002

(51) Int. Cl. G06F 9/00

(52) U.S. Cl. 713/1

(57) ABSTRACT

A processor that executes boot code in its cache memory, and a computer that includes the processor. The processor includes a download boot machine for retrieving the boot code from a sequential access memory device, such as a flash memory or a mass storage device, or from a random access memory such as a serial EEPROM.

### FIELD AND BACKGROUND OF THE INVENTION

The present invention relates to computers and, more particularly, to a computer that boots itself by loading and executing boot code in its processor's cache memory.

FIG. 1 is a high-level partial block diagram of a typical prior art computer 10. Computer 10 includes a processor 12 and several peripheral units that communicate via a bus 14. The peripheral units illustrated in FIG. 1 are memory devices: a main memory 16, a boot code ROM 18 and a mass storage device 20. Computer 10 also includes peripheral units that are not shown in FIG. 1, for managing input and output. For example a typical personal computer 10 includes a keyboard and a mouse for input, and a monitor and a printer for output; and an embedded system computer 10 may include one or more sensors for sensing environmental parameters and one or more actuators for modifying the activities of a larger system within which computer 10 is embedded in response to changing values of those parameters.

Mass storage device 20 typically is a sequential access memory device such as a hard disk. Almost all of the operation of computer 10 consists of processor 12 executing code that is stored in mass storage device 20 to process data that either also is stored in mass storage device 20 or is obtained as input from other peripheral devices. Because mass storage device 20 is a sequential access memory device, it would be unreasonably slow to execute the code directly from mass storage device 20. Therefore, the code to be executed is first loaded into main memory 16, which is a random access memory device, for example a DRAM. Processor 12 then retrieves the instructions that are to be executed from main memory 16, via bus 14. In order to make execution of the code even faster, processor 12 is provided with a cache memory 22 for storing frequently used instructions, to avoid the delays involved in retrieving these instructions from main memory 16 via bus 14 only as needed. Typically, cache memory 22 is a code cache memory, for caching frequently used code, and processor 12 also includes a data cache memory for caching frequently used data.

During the operation of computer 10, the instructions of the operating system of computer 10 also are stored in main memory 16 and are retrieved from main memory 16 by processor 12 for execution. Because main memory 16 is volatile, these instructions must be loaded into main memory 16 from mass storage device 20 when computer 10 is powered up. Therefore, when computer 10 is powered up, processor 12 automatically retrieves and executes “boot code” that is stored in another random access memory device, boot code ROM 18, to initialize the other peripheral devices, to load the operating system into main memory 16 and to start running the operating system.

Processor 12 also retrieves and executes the boot code if for some reason the operating system needs to be re-initialized. Retrieving and executing the boot code is called “booting” computer 10, or, equivalently, “booting” processor 12. Retrieving and executing the boot code upon powering up computer 10 is called a “hard boot”. Retrieving and executing the boot code while computer 10 is running is called a “soft boot”.

FIG. 2 is a high-level partial block diagram of another prior art computer 10′ that includes a processor 12′ that communicates with peripheral devices (not shown) via a bus 14′. Computer 10′ lacks a boot code ROM. Instead, processor 12′ includes a small read-only memory (ROM) 26 in which a small part of the boot code is stored, and a small random access memory (RAM) 24. Connected to processor 12′ at a serial port is a serial EEPROM 28 in which most of the boot code is stored. Just enough of the boot code is stored in ROM 26 to enable processor 12′ to load the rest of the boot code from serial EPROM 28 into RAM 24 and then execute the boot code instructions in RAM 24. (Alternatively, all of the boot code is stored in EEPROM 28; and, in place of ROM 26, processor 12′ has dedicated hardware for loading the boot code from EEPROM 28 to RAM 24.) Note that processor 12′ lacks a cache. Computer 10′ is configured in this manner to keep the size of computer 10′ small enough to be embedded in relatively small systems such as USB devices. One example of processor 12′ is the CY7C646xx, available from Cypress Semiconductor Corporation of San Jose Calif., USA.

### SUMMARY OF THE INVENTION

According to the present invention there is provided a processor including: (a) a download boot machine for retrieving boot code when the processor is booted; and (b) a cache memory for storing the boot code so that the processor can execute the boot code.

According to the present invention there is provided a method of booting a computer that includes a processor, the processor including a cache memory, including the steps of: (a) loading boot code into the cache memory; and (b) executing the boot code that is loaded in the cache memory, by the processor.

The present invention is of a processor that executes boot code from its cache memory. For this purpose, the processor is provided with a download boot machine for retrieving the boot code when the processor is booted. Preferably, the cache memory is a code cache memory. The scope of the present invention also includes a computer whose processor is the processor of the present invention. Preferably, this computer also includes a memory device from which the download boot machine retrieves the boot code. Preferably, the memory device is a sequential access memory device that includes a mass storage device, or includes a flash memory such as a NAND flash memory or an AND flash memory, or emulates a NAND flash memory interface or an AND flash memory interface. Alternatively, the memory device is a random access memory device that includes a serial EEPROM.

The scope of the present invention also includes a method of booting a computer whose processor includes a cache memory, by loading boot code into the cache memory and executing the boot code thus loaded. Preferably, the processor is provided with a download boot machine for effecting the loading of the boot code into the cache memory. Preferably, the boot code is stored in a memory device, and the loading includes retrieving the boot code from the memory device. Preferably, the cache memory is mapped into a boot area of the processor, and the cache memory is locked, prior to executing the boot code. Optionally, at least a portion of the cache memory is reversibly converted to RAM prior to the loading therein of the boot code.

### BRIEF DESCRIPTION OF THE DRAWINGS

The invention is herein described, by way of example only, with reference to the accompanying drawings, wherein:

FIGS. 1 and 2 are high-level partial block diagrams of two prior art computers;

FIGS. 3, 4 and 5 are high-level partial block diagrams of two computers of the present invention.

### DESCRIPTION OF THE PREFERRED EMBODIMENTS

The present invention is of a processor whose boot code is executed from the processor's own cache memory, and of a computer based on such a processor.

The principles and operation of a processor and a computer according to the present invention may be better understood with reference to the drawings and the accompanying description.

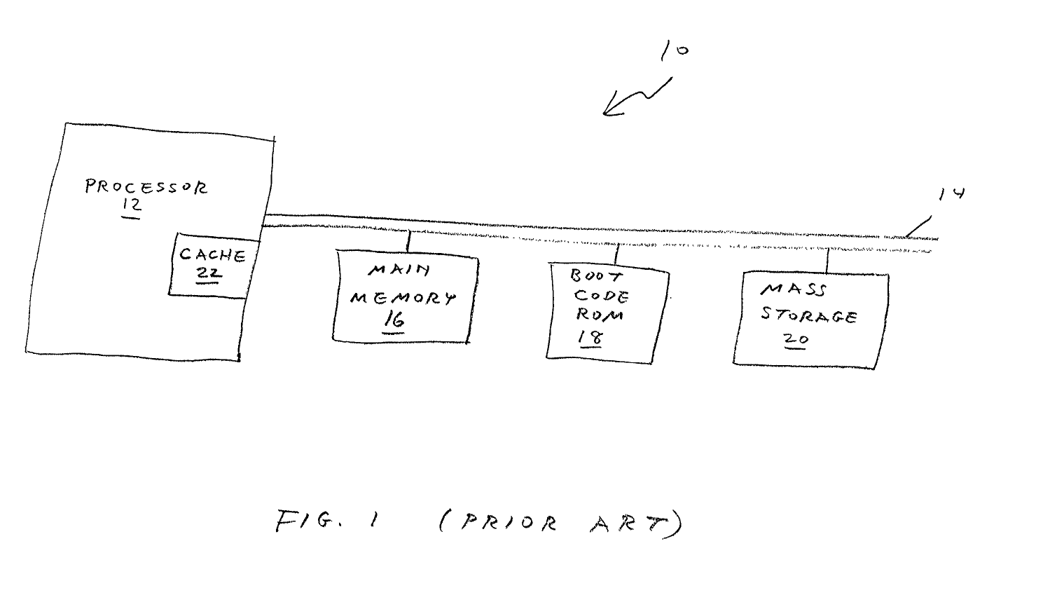

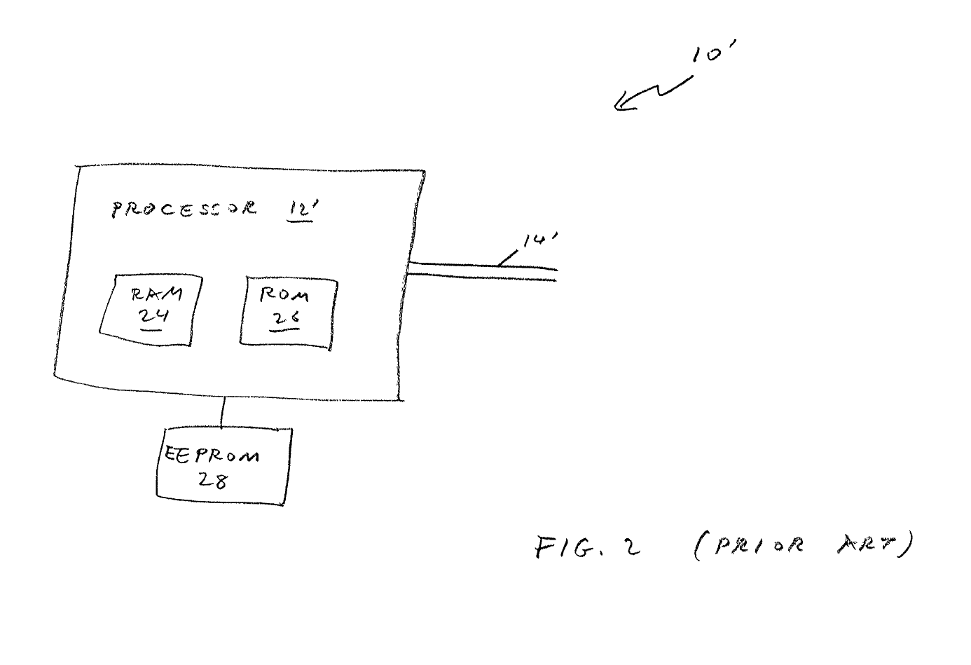

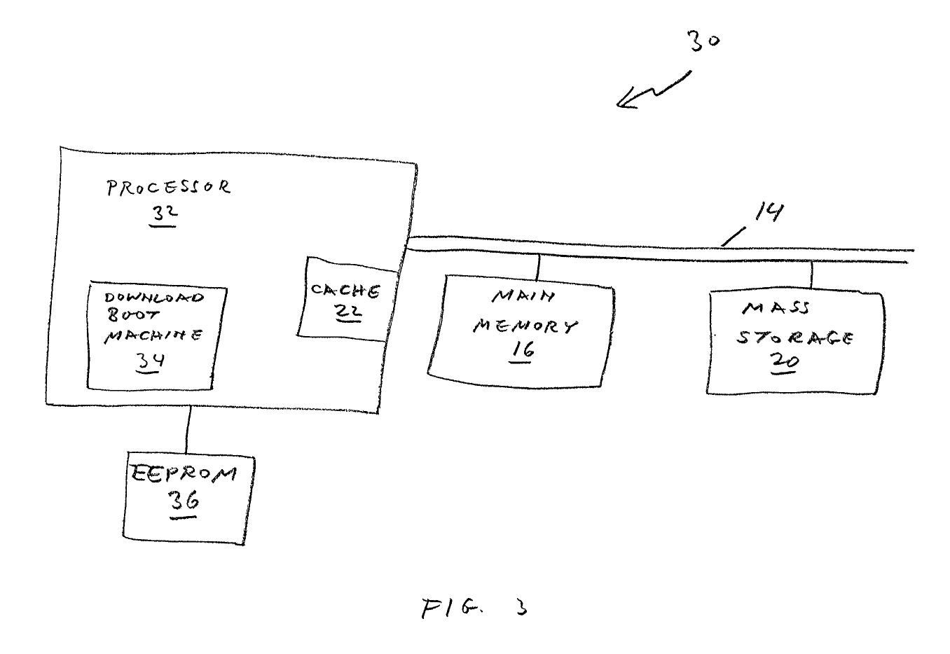

Returning now to the drawings, FIG. 3 is a high-level partial block diagram of a computer 30 of the present invention. Computer 30 shares most of the components of computer 10 of FIG. 1, and these components are indicated in FIG. 3 with the same reference numerals as are used in FIG. 1. Note, however, that computer 30 lacks boot code ROM 18. Instead, processor 32 of computer 30 includes a download boot machine 34. Processor 32 also is connected at a serial EEPROM interface to a serial EEPROM 36 in which the boot code of computer 30 is stored. When computer 30 is booted (either a hard boot or a soft boot), download boot machine 34 retrieves the boot code from EEPROM 36 and loads the boot code into code cache memory 22. Code cache memory 22 then is mapped into a boot area of processor 30, and processor 30 then executes the boot code.

As noted above, the purpose of code cache memory 22 in normal operation is to store frequently used instructions. Therefore, in normal operation, processor 30 decides dynamically, based on actual instruction usage, which instructions to store in code cache memory 22. Instructions that are stored in code cache memory 22, and that turn out in retrospect to be used less frequently than other instructions, may be replaced with those other instructions. During a boot, all of the instructions loaded into code cache memory 22 should be executed. Therefore, after the boot code has been loaded into code cache memory 22, code cache memory 22 is locked.

The advantage of computer 30 over computer 10 lies in the lower cost of computer 30. A boot code ROM typically costs between $1 and $4. A serial EEPROM typically costs between $0.40 and $0.60. The other components of computers 10 and 30 are substantially identical in cost. This is a small difference per unit; but it can be significant in production runs of hundreds of thousands or millions of devices in which computer 30 is embedded.

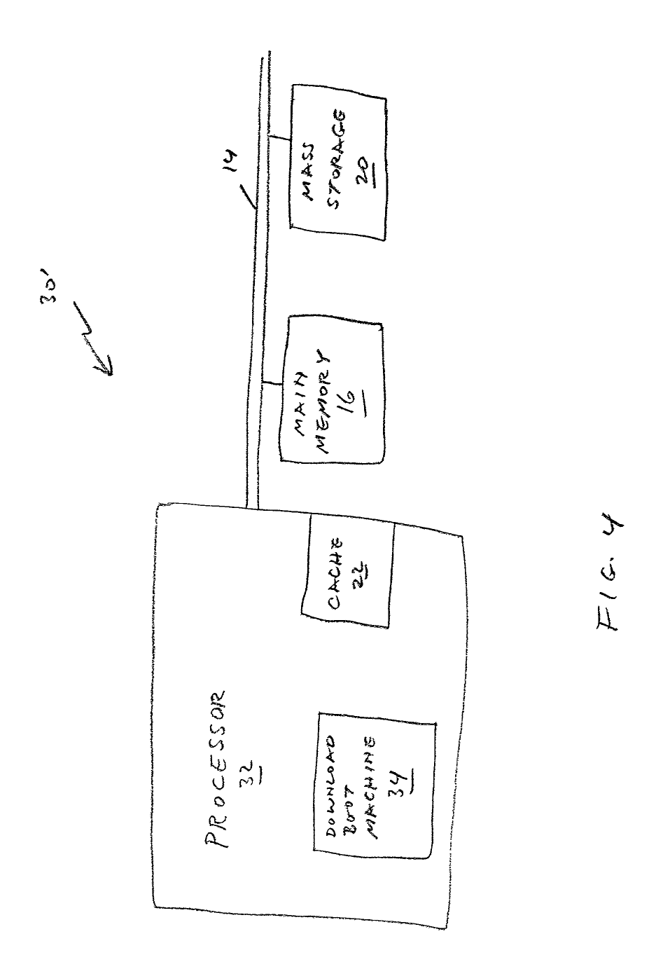

FIG. 4 is a high-level partial block diagram of a second computer 30′ of the present invention. Computer 30′ is identical to computer 30 except for lacking EEPROM 36. When computer 30′ is booted, download boot machine 34 retrieves the boot code from mass storage device 20 and loads the boot code into code cache memory 22. The rest of the boot procedure of computer 30′ is as described above for computer 30.

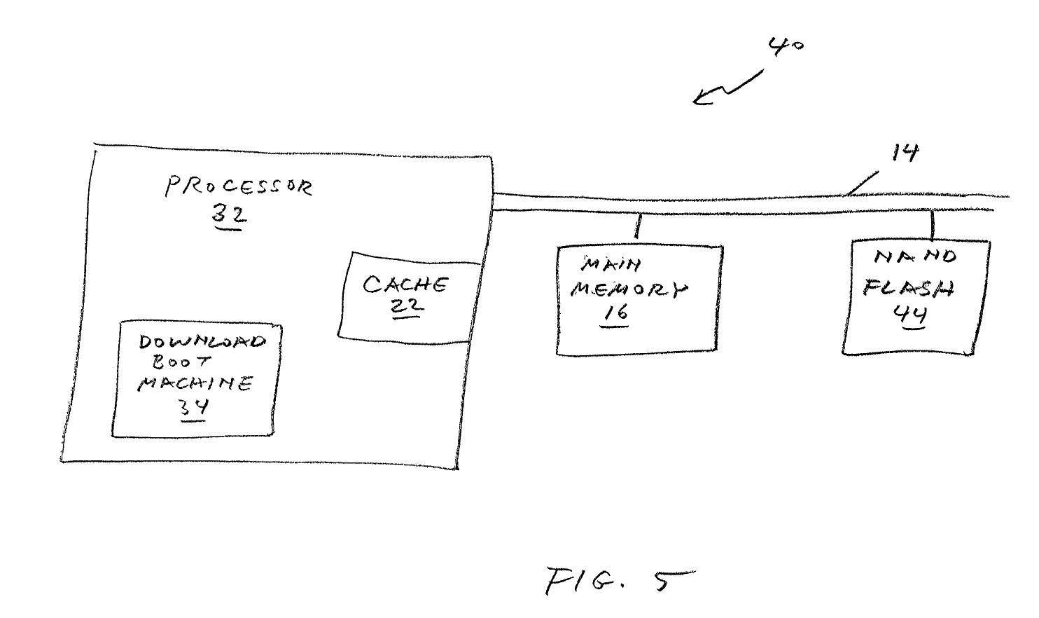

FIG. 5 is a high-level partial block diagram of a third computer 40 of the present invention. Computer 40 shares most of the components of computers 30 and 30′ of FIGS. 3 and 4, and these components are indicated in FIG. 5 with the same reference numerals as are used in FIGS. 3 and 4. In computer 40, the mass storage device is a flash memory 44, and the boot code is stored in a predetermined, fixed location in flash memory 44. Flash memory 44 may be either a NAND flash memory, as illustrated, or an AND flash memory. When computer 40 is booted, download boot machine 34 retrieves the boot code from flash memory 44 and loads the boot code into code cache memory 22. The rest of the boot procedure of computer 40 is as described above for computer 30.

Mass storage device 20 was described above as a sequential access memory device. A flash memory, such as flash memory device 44, is a random access device, but on a sector level. As understood herein, a “random access” memory device is a device in which individual words can be addressed and read. “Random” access on a granularity level higher than the word level is understood herein to be “sequential” access. Therefore, for the purposes of the present invention, flash memory 44 is a sequential access memory device.

As is known to those skilled in the art, a cache memory is similar to a conventional random access memory (RAM), the difference between the two being that access to a cache memory is more complicated than access to a conventional RAM. A conventional RAM is accessed for reading or writing merely by specifying the address of the word that is to be read or written. A cache memory is accessed in this manner, but also in other ways. For example, reading from an address in a cache memory may be contingent on the content of that address being valid. In general, the extra access methods of a cache memory are implementation-dependent. The scope of the present invention includes: disabling these extra access methods for part or all of code cache memory 22; loading the boot code into the portion of code cache memory, the access to which has been thus disabled (so that this portion of code cache memory 22 is accessed only like conventional RAM); and executing the boot code from the portion of code cache memory 22, the access to which has been thus disabled. After computer 30 or 30′ has been booted, the extra access methods that distinguish code cache memory 22 from conventional RAM are again enabled. The disabling of the extra access methods of all or part of code cache memory 22 is referred to herein as “converting all or part of code cache memory 22 to RAM.

While the invention has been described with respect to a limited number of embodiments, it will be appreciated that many variations, modifications and other applications of the invention may be made.

What is claimed is:

1. A processor comprising:
(a) a download boot machine for retrieving boot code when the processor is booted; and
(b) a cache memory for storing said boot code so that the processor can execute said boot code.

2. The processor of claim 1, wherein said cache memory is a code cache memory.

3. A computer comprising:
(a) the processor of claim 1.

4. The computer of claim 3, further comprising:
(b) a memory device from which said download boot machine retrieves said boot code.

5. The computer of claim 4, wherein said memory device is a sequential access memory device.

6. The computer of claim 5, wherein said sequential access memory device includes a mass storage device.

7. The computer of claim 5, wherein said sequential access device includes a flash memory.

8. The computer of claim 7, wherein said flash memory is a NAND flash memory.

9. The computer of claim 7, wherein said flash memory is an AND flash memory.

10. The computer of claim 5, wherein said sequential access memory device emulates a NAND flash memory interface.

11. The computer of claim 5, wherein said sequential access memory device emulates an AND flash memory interface.

12. The computer of claim 4, wherein said memory device is a random access memory device.

13. The computer of claim 12, wherein said random access memory device includes a serial EEPROM.

14. A method of booting a computer that includes a processor, the processor including a cache memory, comprising the steps of:
(a) loading boot code into the cache memory; and
(b) executing said boot code that is loaded in the cache memory, by the processor.

15. The method of claim 14, further comprising the step of:
(c) providing the processor with a download boot machine for effecting said loading.

16. The method of claim 14, further comprising the step of:
(c) storing said boot code in a memory device, said loading including retrieving said boot code from said memory device.

17. The method of claim 14, further comprising the step of:
(c) locking said cache memory, prior to said executing of said boot code.

18. The method of claim 14, further comprising the step of:
(c) mapping said cache memory into a boot area of the processor, prior to said executing of said boot code.

19. The method of claim 14, further comprising the step of:
(c) reversibly converting at least a portion of the cache memory to RAM, prior to said loading of said boot code into the cache memory, said boot code then being loaded into said at least portion of the cache that has been converted to RAM.
